(19) United States
(12) Patent Application Publication
(10) Pub. No.: US 2025/0135886 A1
(43) Pub. Date: May 1, 2025

(54) METHOD FOR ADJUSTING A SCREEN

(71) Applicant: AUDI AG, Ingolstadt (DE)

(72) Inventors: Ulrich MÜLLER, Ingolstadt (DE); Tobias MOLL, Ingolstadt (DE)

(73) Assignee: AUDI AG, Ingolstadt (DE)

(21) Appl. No.: 18/687,719

(22) PCT Filed: Aug. 5, 2022
(86) PCT No.: PCT/EP2022/072069

§ 371 Date: May 7, 2024

(30) Foreign Application Priority Data
Aug. 31, 2021 (DE) 10 2021 122 465.9

(51) Int. Cl. B60K 35/53; G06F 3/14; G06F 18/20

(52) U.S. Cl. CPC B60K 35/53; G06F 3/14; G06F 18/29; B60K 2360/195

(57) ABSTRACT

The present disclosure relates to a method for adjusting a screen of a vehicle, wherein the screen is provided for a front passenger of the vehicle, and wherein it is originally provided to display at least one display element. The at least one display element is analyzed to determine, whether the at least one display element is dynamic and/or is provided only for the front passenger. Based on the determination, at least one static display element that differs from the display element originally provided for display is alternatively displayed from the driver's perspective.

### TECHNICAL FIELD

The present disclosure relates to a method for adjusting a screen of a vehicle and to a system for adjusting a screen of a vehicle.

### BACKGROUND

An operating device of a vehicle for a driver and a front passenger, each of whom is assigned different operable vehicle functions, is known from EP 2 675 649 B1.

DE 10 2005 035 111 A1 describes an operating and display system for a vehicle with a driver and a front passenger, each of whom uses a central display unit from a different viewing angle.

A display device of a motor vehicle with a display surface that can be used collectively by a driver and a front passenger is described US 2007/0129864 A1.

Against this background, an object was to adjust a screen in a vehicle in a suitable manner for a driver and front passenger.

### BRIEF DESCRIPTION OF DRAWINGS/FIGURES

The present disclosure is schematically illustrated in the drawing by means of embodiments and is described schematically and in detail with reference to the drawing.

FIG. 1 is a schematic view of an embodiment of the system according to the present disclosure for carrying out one embodiment of the method according to the present disclosure.

### DETAILED DESCRIPTION

This object is achieved by a method and a system having the features of the independent claims. Embodiments of the method and the system can be found in the dependent claims and the description.

The method according to the present disclosure is intended for adjusting a screen of a vehicle, for example a motor vehicle, wherein the screen is provided for a front passenger of the vehicle and is designed and/or to be designated as a front passenger screen for example. It is originally provided that at least one display element is displayed, is to be displayed and/or can be displayed on the screen, wherein the at least one originally provided display element is first analyzed or examined, for example checked, wherein it is determined whether the at least one originally provided display element, for example from a plurality of display elements, is dynamic or includes moving images and/or is addressed or directed only to the front passenger and is therefore provided only for the front passenger. In this case, at least one static display element, which differs from the display element originally provided for display, is displayed on or with the screen from the driver's perspective as a substitute for the at least one dynamic display element originally provided and/or provided only for the front passenger.

In addition, the at least one display element that was originally dynamic and/or provided only for the front passenger is displayed unchanged for the front passenger.

A check is initially made for the at least one originally provided item of display content or corresponding image content to see whether this content is static or dynamic and for example includes a video, wherein dynamic display content is shown in its original form only to the front passenger. This dynamic display content, on the other hand, is replaced for the driver. An originally static item of display content is shown to both the front passenger and the driver in its original form. Alternatively or additionally, the at least one originally provided item of display content is analyzed with regard to its use, wherein with regard to the display content a check is generally made to see whether it is or will be provided only for the front passenger and not for the driver, wherein this display content is replaced for the driver. If such display content is provided, e.g. is suitable, for both the driver and the front passenger, it is shown in its original form to both the driver and the front passenger.

As static display content, the driver can be shown a monochrome, e.g. white or black, surface, a different-colored or colorful surface, or an image, as an alternative. It is possible to set a privacy mode or private mode for the front passenger and thus stop the driver from being able to view it.

In one embodiment, the at least one original display element is analyzed in a window-based and/or graphics-based manner, it being possible for the at least one originally dynamic display element to be recognized in a graphics-based and/or window-based manner.

As a rule, the at least one display element originally provided only for the front passenger, and for which specific display content is used and/or provided, is displayed to the front passenger as originally provided, irrespective of whether it is originally displayed dynamically or statically. In contrast, the driver is presented only with an alternative static display element that differs from an originally static display element that is or shall be provided only for the front passenger.

The at least one originally provided display element is analyzed by a computing unit with regard to its properties before it is displayed on the screen. If it is not suitable and/or provided for the driver, a private mode is activated for this at least one display element, wherein said element is replaced on the screen by the alternative display element from the driver's perspective.

In a further embodiment, a driving situation of the vehicle is taken into account, for example when analyzing and/or displaying the at least one display element. If the vehicle is moving, the static display element is shown to the driver as am alternative to the dynamic display element. If the vehicle is stationary, the originally dynamic display element can also be shown to the driver unchanged. Instead of a display element that is only provided for the front passenger, the driver is alternatively presented with an alternative static display element irrespective of whether the vehicle is moving or stationary. A personal relationship between the front passenger and the driver can also be taken into account, i.e. whether they are part of the same family, are friends, or are strangers to each other, for example if the front passenger is sitting in a cab as a vehicle next to a cab driver who is a stranger to him as the driver. If the driver and the front passenger are friends or belong to the same family, for example, a further check is made to see whether or not the driver can or is permitted to also be shown a display element, depending on its display content or image content. If the driver and front passenger are strangers, the display element provided only for the front passenger is also shown only to the front passenger in its original form. This is also possible with car sharing, for example, if the vehicle is used by different drivers alternating. Different definable categories for private modes and/or privacy can be taken into account, which are stored in a database for example and determine which type of display content is provided only for the front passenger and not for the driver, wherein these categories are retrievable from the database and accessed by the computing unit.

The entire display content of the screen or display is generated by the computing unit. Different applications can be visible on the screen depending on usage. As static display content or as a static display element, an application can include for example navigation data, information, for example media information, radio advertisements, weather data, etc. Furthermore, moving display content or a moving display element can be displayed at the request of the front passenger. These can be different applications (apps), such as YouTube, Snapchat, Instagram, or dynamic websites. In addition, streaming content such as Netflix, Amazon Prime or other streaming services are conceivable as movable display content. Many of the applications and display content that can thus be displayed include moving regions as display elements, e.g., on YouTube, an actively running video, and static regions as display elements, for example a preview region or navigation region. The computing unit decides which original display elements can distract the driver and replaces these with other display elements that are visible only to the driver. An alternative and therefore different display element is also generated by the computing unit. In the simplest case, this alternative display element can be or include a darkened area. However, a graphic alternative display element is also conceivable, e.g. a pattern, a logo, or the like, which is stored in the computing unit in a predefined manner. In a further embodiment, predetermined other display elements can also be displayed. For example, a film that the front passenger sees on the screen is overlaid for the driver with a navigation map as an alternative static display element, wherein the driver only sees the navigation map instead of the film.

The system according to the present disclosure is configured for adjusting a screen of a vehicle, wherein the screen is provided for and/or assigned to a front passenger of the vehicle, wherein the screen is configured as a front passenger screen. The system has a computing unit, for example a control unit. Originally it is provided that at least one display element is displayed, is to be displayed and/or can be displayed on the screen. The computing unit is designed to first analyze, for example to check, the at least one originally provided display element and to determine whether the at least one originally provided display element, for example from a plurality of originally provided display elements, is dynamic or includes moving images and/or whether it is addressed and/or directed only to the front passenger, wherein it is correspondingly provided only for the front passenger. The computing unit is further configured to control the screen and to cause it to display or show, from the driver's perspective, at least one static display element on or with the screen as a substitute for the at least one dynamic display element originally provided and/or provided only for the front passenger, which static display element differs from the display element originally provided for display, and to display or show to the front passenger, in the standard manner, the at least one display element that is originally dynamic and/or provided only for the front passenger in unchanged form.

The computing unit is configured to analyze or examine, using artificial intelligence, the at least one display element that is originally to be displayed with regard to its technical properties and/or its display content. With regard to the technical properties, the computing unit distinguishes whether the at least one display content is originally dynamic or static.

In one embodiment, the system has the screen which is arranged in front of a seat for the front passenger with respect to a forward direction of travel of the vehicle, and is used as a front passenger screen.

It is possible for an embodiment of the presented method to be carried out with an embodiment of the presented system. With the method and the system, a content-dependent adjustment and/or switching of the screen or monitor or display or display field provided for or assigned to the front passenger is possible. In one embodiment, the screen is integrated into a control panel and/or is designed or can be designated as a control panel. It is analyzed, for example checked, how the at least one original display element is technically constructed or designed, with a distinction being made between at least one originally static display element and at least one originally dynamic display element with regard to a technical property.

Alternatively or additionally, an analysis is performed as to whom the display content of the at least one original display element is provided for, i.e. whether it is provided only for the front passenger but not for the driver, or for both. Depending thereon, the private mode is set for this at least one originally provided display element, wherein the at least one display element with the display content is displayed in this case only to the front passenger, and wherein the driver is then presented only with an alternative static display element in order to conceal the originally provided display element from the driver or to shield it from the driver.

If the method takes into account whether the display content of the at least one display element is provided or suitable only for the front passenger alone, or possibly also for the driver, in one embodiment an examination or analysis is carried out as to with which software-supported program or application the at least one display element with the provided display content is displayed. It is possible to decide based on the program whether this at least one item of display content is provided only for the front passenger alone or possibly also for the driver, wherein among other things an analysis is carried out as to whether this program is configured, in terms of its function, to display private display content. This can be, for example, a program for displaying personal messages, for example emails, and/or a program for displaying a communicative and/or social network for different users, wherein confidential display content is displayed in each case. If, for example, an Internet browser is used as the at least one display element, an analysis is carried out as to whether a selected Internet page is designed or provided to display private and/or confidential display content, further taking into account whether this Internet page is encrypted and/or protected and can only be viewed by entering identification, such as a password. Furthermore, the program for displaying the display content is also used to check whether it is configured for example as a video player and thus for displaying videos, wherein it is determined that the thus displayed display content of a relevant display element is generally dynamic.

The screen is usually adjusted and/or controlled by the computer unit, e.g. control unit, with software support. In this case, in one embodiment the at least one originally provided display element is already analyzed by the computing unit with regard to its technical and/or display content properties before it is displayed on the screen, i.e. the front passenger screen.

As a rule, a plurality of display elements are shown on the screen, wherein a region or portion on a surface of the screen is provided for each display element. Depending on software and/or artificial intelligence used by the computing unit, the at least one display element and thus the region or portion on the screen provided for this purpose is set to private mode, wherein it is displayed only for the front passenger in its originally provided form, or is not set to private mode, wherein it is displayed unchanged for both the front passenger and the driver. An algorithm used by the computing unit to adjust display elements for the front passenger and the driver is, for example, rule-based and/or created using artificial intelligence. If the alternative display element is shown or displayed to the driver instead of the originally provided display element, the originally provided display element in its originally provided form is switched off for the driver, and is shown only to the front passenger on the screen.

Furthermore, the at least one originally provided display element is classified by the computing unit as to whether it is also to be displayed to the driver with regard to its originally provided form or not, in which latter case it is changed and is displayed statically to the driver. In the process, the computing unit takes into account different criteria according to which a decision is made about how the at least one originally provided display element is to be shown to the driver on the screen. One criterion relates to a technical design or a technical structure of the at least one display element, wherein an analysis is carried out to find whether it has static or dynamic, and therefore animated, display content. According to a further criterion, an analysis is carried out to find the type of software-supported window in which the at least one display element is displayed, and thus the program and/or use or application with which the at least one display element is displayed. Among other things, this takes into account whether the at least one display element is to be displayed for example in a video window, and therefore comprises moving images and/or is designed as an advertisement or promotion. According to a further criterion, textual content of the at least one display element is analyzed, taking into account, among other things, whether the at least one display element, according to its originally provided form, comprises confidential information that is usually provided only for the front passenger. This can also take into account whether the original display content is used to display e.g. an email and/or a communication thread. The driving situation of the vehicle, as described above, is taken into account as a further criterion. According to a further criterion, a viewing direction of the driver of the vehicle, usually a viewing direction of at least one eye of the driver, is also detected and/or determined by sensors. Taking this criterion into account, a possible embodiment of the method provides that the at least one display element originally provided is only displayed in changed form for the driver, i.e. replaced by an alternative static display element, if the driver's viewing direction is or becomes oriented in the direction of the screen provided for the front passenger. Furthermore, the environment of the vehicle in which the driver and the front passenger are located is taken into account as a criterion. Here, among other things, a light intensity of the environment is taken into account, which depends for example on whether it is bright in the environment, usually during the day, or dark in the environment, usually at night. Taking the light intensity into account, it is possible inter alia to adapt at least a color and/or brightness of the at least one display element to be displayed to the driver to the environment as an alternative or replacement.

The method presented can be carried out for a screen that is designed or is referred to as a dual-view display, dual-layer backlight or double backlight.

With such a screen, it is possible to display different display elements or the same display elements to the driver and the front passenger. In such a screen for dual display of display elements, the display elements to be displayed are classified according to whether they are originally dynamic or not and/or whether, with regard to their display content, they are provided only for the front passenger or possibly also for the driver. Here the at least one correspondingly classified display element is changed and displayed statically to the driver on a region provided for this purpose of the screen configured for dual display. Alternatively or additionally, the at least one display element is overlaid by an alternative static display element, regardless of the specific design of the screen.

With the method and the system, content-based switching, for example private switching, of display elements that include originally provided moving images and/or of display elements with protected display content provided only for the front passenger is possible. Usually, a plurality of display elements can or are to be shown on the screen at a time, wherein each display element is checked by the computing unit with regard to its properties before it is displayed in a region or portion of the screen provided therefor. Thus, in the case in which a plurality of different display elements can be displayed or are to be displayed, it is possible to set at least part of the screen to private mode and in doing so to replace, for the driver or from the driver's perspective, display elements having dynamic or moving display content and/or display elements having display content provided only for the front passenger with display elements having alternative static display content and to correspondingly display this as an alternative so that the driver does not see a corresponding display element in its originally provided form and, for example in the case of moving display content, is not distracted thereby while controlling the vehicle, e.g. steering it.

In a further possible embodiment, both a position of at least one eye of the front passenger relative to the screen and a position of at least one eye of a driver of the vehicle relative to the screen are detected and/or determined by sensors as standard. In addition, at least one optical property of a view region of the screen is usually quantitatively and automatically adjusted depending on the position of the at least one eye of the front passenger and the at least one eye of the driver. In an embodiment of the method, the view region or an eyebox of the screen is automatically adjusted for a particular viewer, i.e. the front passenger and/or the driver. In one embodiment, one dimension as a property of the view region or the eyebox has the shape of a rectangular truncated pyramid with a rectangular base, and/or at least one light cone, for example a plurality of light cones. To adjust the dimension of the view region, it is possible that an opening angle at which outer surfaces of the truncated pyramid-shaped light body are oriented relative to one another and/or an opening angle of the at least one light cone is/are automatically adjusted, for example is/are varied depending on the positions described above. In this case, the at least one original display element provided only for the front passenger is displayed within the view region and is also visible only to at least one eye that is located within the view region, e.g. of the light body. Outside this view region, only the at least one display element to be displayed statically as a substitute is visible to the at least one eye of the driver. It is possible for the view region or the eyebox to be limited by outer surfaces of the usually truncated pyramid-shaped light body. In a possible embodiment of the method, the outer surfaces of this light body are automatically adjusted and/or adapted taking into account the positions of the at least one eye of the front passenger and the at least one eye of the driver. Among other things, it is possible here to automatically increase or decrease, and thus adapt, an opening angle at which two outer surfaces of the light body which delimit the light body. When adjusting the opening angle in this way, the fact that the at least one eye of the driver is outside the described light body is taken into account, wherein it is accordingly avoided that the at least one eye of the driver is inside the light body.

The screen is configured to display original display content and to emit it into an interior of the vehicle, e.g. a motor vehicle. In another possible embodiment, the system has an additional optical layer that is arranged on the screen and covers it. The additional optical layer, if activated, is configured to generate additional light and to emit it only in the direction of a driver of the vehicle and to overlay the at least one original display content of the screen for the driver with the additional light and to instead display to the driver the at least one alternative display element to be alternatively displayed. The computing unit is configured to set an additional angle, which limits an angular range of the additional light from the additional optical layer with respect to the surface of the screen, to be smaller than an angle of view at which the driver looks at the screen. The additional light, which overlays the original display content of the screen and with which at least one display element shows the alternative display content, is emitted or radiated exclusively within the angular range in the direction of the driver. Furthermore, it is possible for the additional angle to be set depending on a distance of the at least one eye of the front passenger and/or on a distance of the at least one eye of the driver from the screen. Furthermore, it is possible that the additional angle with which the additional light is limited is also set depending on a viewing angle of the at least one eye of the driver and/or of the front passenger. It is possible for this additional angle to correspond to the opening angle of the view region, for example of the light body, described above.

In a graphics-based analysis of the at least one originally provided display element, an examination is performed to see, among other things, whether its display content and thus the display element changes graphically during a definable period of time, usually within one second, and is thus configured as dynamic display content for a corresponding display element. It is also possible, for example, to recognize moving advertisements, which is replaced by an alternative static display element.

In a content-dependent analysis of the at least one display element, which is carried out by the computing unit independently of an alternative graphic analysis, a check is made to see whether the at least one display element is to be used to display emails to the front passenger, for example confidential emails, whether for example social media provided for the front passenger are to be displayed, or whether an incoming call is to be displayed for the front passenger in order to display a function of a telephone. It is therefore possible to examine the at least one display element for the presence of private and/or confidential display content for the front passenger, with the display element being replaced by an alternative display element for the driver.

In one embodiment, it is possible for the computing unit to search for digital and/or optical markings on the at least one display element when analyzing the at least one originally provided display element, wherein such markings can also be provided in a video or video stream as a display element, for example display content.

The method is usually carried out for the entire screen, with all display elements being analyzed by the computing unit with regard to their properties. If only one display element is originally to be displayed which is dynamic and/or only provided for the front passenger, only this one display element is replaced by the alternative static display element provided for the driver, wherein in this case this alternative static display element is displayed on the entire screen. If only some display elements among a plurality of display elements are dynamic and/or only provided for the front passenger, only these display elements are replaced by alternative static display elements on the screen for the driver. In this case, the screen is only partially adapted for the driver by displaying alternative display elements. If it is provided that the at least one alternative display element is monochrome, e.g. black, the screen is only partially switched to monochrome, e.g. black, for the driver or based on the driver's perspective.

All originally static and therefore non-moving display elements, such as a status bar, a control element, a clock time and/or other information, are displayed both to the front passenger and to the driver according to their originally provided form, regardless of whether or not at least one other originally provided display element is replaced by an alternative display element for the driver. This makes it possible to obtain a better overall visual impression of the screen, since, for example, large black regions that are displayed only to the driver are avoided. Private switching provided in the method is automatically carried out by the computing unit only for relevant display elements or corresponding image regions of the screen.

In one embodiment, the screen is only partially switched or set to private mode depending on the properties of each of the display elements to be displayed thereon. The driver is shown both originally provided display elements and alternative static display elements. For example, a link between private display content recognized by the computing unit, which is provided only for the front passenger, within all display elements that can be shown and technical private switching of this display content is taken into account.

It goes without saying that the features mentioned above and those still to be explained below can be used not only in each of the specified combinations, but also in other combinations or alone without departing from the scope of the present disclosure.

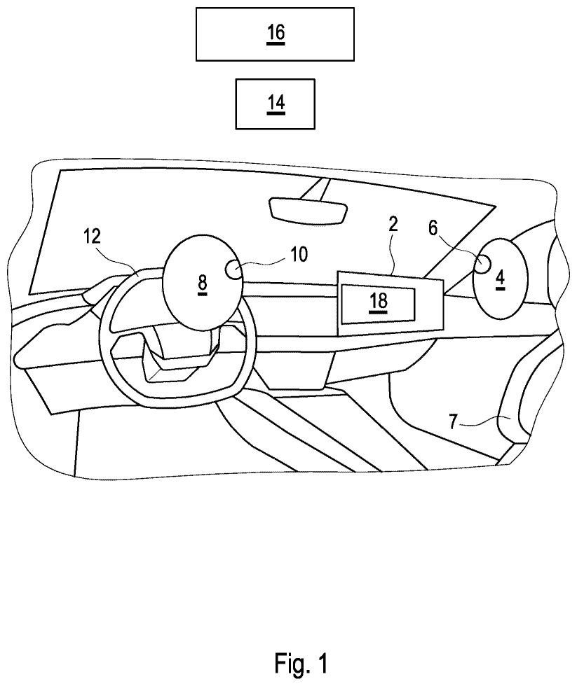

FIG. 1 is a schematic view of an interior of a vehicle designed or to be designated here as a motor vehicle, in which a driver is seated on a seat on the driver's side, or driver's seat (not shown further), behind a steering wheel 12, the driver having a head 8, one eye 10 of which is shown schematically here. Next to the steering wheel on the front passenger side, a front passenger sits on a further seat 7, or front passenger seat, whose head 4 and one eye 6 are shown schematically here. It is provided here that the seat 7 for the front passenger and thus also the front passenger sitting on it are arranged behind a screen 2 or display, wherein this screen 2 is usually provided for the front passenger and is also assigned to the front passenger for viewing display content on the screen 2.

The system according to the present disclosure has a sensor 14 and a computing unit 16, which are shown schematically in FIG. 1. It is optionally possible for the screen 2 to also be configured as a component of this system.

In the embodiment of the method according to the present disclosure, it is originally provided that at least one display element 18 is displayed or is to be displayed on the screen. The at least one originally provided display element 18 is analyzed by the computing unit 16, for example checked, and it is further determined whether the at least one originally provided display element is dynamic and/or animated with respect to its technical properties and comprises moving images as standard. Alternatively or additionally, the computing unit 16 analyzes, e.g. checks, and furthermore determines whether the originally provided display element 18 is directed only to the front passenger and/or is provided only for the front passenger with regard to its properties. Depending on the particular properties, the screen 2 is controlled by the computing unit 16 and causes at least one static display element to be alternatively displayed from a driver's perspective for the at least one dynamic display element 18 originally provided and/or provided only for the front passenger, and wherein the at least one display element that is originally dynamic and/or is provided only for the front passenger is displayed unchanged for the front passenger. The display element shown to the driver or from the driver's perspective as a substitute or alternative, and which differs from the original display element to be shown, can for example comprise an image.

When carrying out the method, it is possible that at least during a trip when the driver is controlling the vehicle and steering with the steering wheel 12, the driver will not be distracted by the display content on the screen 2, but that the front passenger will still be able to see this display content on the screen 2.

For this purpose, the method provides in a possible embodiment that the sensor 14 detects and/or determines a position of at least one eye 10, usually both eyes 10, of the driver and/or a position of at least one eye 6, usually both eyes 6, of the front passenger relative to the screen 2. Here, a viewing direction and thus a viewing angle of the at least one eye 6, 10 relative to the screen 2 is also taken into account. If the sensor 14 and/or the computing unit 16 determine(s) that the distance of the at least one eye 10 of the driver to the screen 2 is less than a threshold value provided for this purpose, and/or that the viewing direction of the at least one eye 10 of the driver is oriented toward the screen 2, the originally provided display content shall be replaced, as described above. In this case a private mode or protection from the driver's view is provided for the originally provided display content.

### REFERENCE SIGNS

2 screen
4 head
6 eye
7 seat
8 head
10 eye
12 steering wheel
14 sensor
16 computing unit
18 display element

1.-8. (canceled)

9. A method for adjusting a screen of a vehicle provided for a front passenger of the vehicle, the method comprising:
analyzing at least one display element, the at least one display element being originally provided for display on the screen;
determining whether the at least one display element is dynamic and/or provided only for the front passenger; and
based on the determination, displaying, on the screen from a driver's perspective, an alternative, the alternative being at least one static display element that differs from the at least one display element originally provided for display.

10. The method of claim 9, wherein the analyzing the at least one display element originally provided includes analyzing based on graphics.

11. The method of claim 9, wherein the analyzing the at least one display element originally provided includes analyzing on a type of software-supported window in which the at least one display element is displayed.

12. The method of claim 9, further comprising displaying the at least one display element originally provided to the front passenger.

13. The method of claim 9, further comprising displaying the at least one display element originally provided based on a driving situation of the vehicle.

14. A system for adjusting a screen of a vehicle provided for a front passenger of the vehicle, the system comprising:
a computing unit configured to:
analyze at least one display element, the at least one display element being originally provided for display on the screen;
determine whether the at least one display element is dynamic and/or provided only for the front passenger; and
based on the determination, display, on the screen from a driver's perspective, an alternative, the alternative being at least one static display element that differs from the at least one display element originally provided for display.

15. The system of claim 14, wherein the computing unit is configured to analyze the at least one display element originally provided for display using artificial intelligence.

16. The system of claim 14, wherein the screen is arranged in front of a seat for the front passenger with respect to a forward direction of travel of the vehicle.
